(19) United States
(12) Patent Application Publication
(10) Pub. No.: US 2005/0126722 A1
(43) Pub. Date: Jun. 16, 2005

(54) Slat structure

(76) Inventor: Leslie Nien, Changhua Hsien (TW)

Correspondence Address: TROXELL LAW OFFICE PLLC, SUITE1404, 5205 LEESBURG PIKE, FALLS CHURCH, VA, 22041, US

(21) Appl. No.: 10/805,301

(22) Filed: Mar. 22, 2004

(30) Foreign Application Priority Data
Dec. 10, 2003 (TW) 092221713

(51) Int. Cl. E06B 3/06

(52) U.S. Cl. 160/236

(57) ABSTRACT

A slat structure includes a plurality of support sticks integrally woven with a woven fabric into a piece of decoration article wherein the support sticks are equidistantly wrapped in place by the woven fabric, and an adhesive layer is coated at the upper and lower surfaces of the decoration article thereon respectively, securely binding the woven fabric and the support sticks thereby to form a hard and solid piece of the decoration article which is then laterally or vertically dissevered in equal distance into specific horizontal-type or vertical-type slat pieces. Thus, via the weaving of the woven fabric, the slat pieces thereof are equipped with artistic diagrams of rich colors and three-dimensional designs at the upper and lower surfaces thereon. Besides, the woven fabric, securely hold by the supported sticks and further bound by the adhesive layer, can efficiently avoid the loose yarns in cutting operation thereof, preventing the slat pieces from coming or wearing off after long time of repeated friction in use so that the upper and lower surfaces of the slat pieces thereof can be precisely protected by the adhesive layers coated thereon to achieve longer using lifespan of the slat pieces thereof.

### BACKGROUND OF THE INVENTION

The present invention is related to a slat structure, including a plurality of support sticks integrally woven with a woven fabric into a piece of decoration article wherein the support sticks are equidistantly wrapped in place by the woven fabric, and an adhesive layer is coated at the upper and lower surfaces of the decoration article thereon respectively, securely binding the woven fabric and the support sticks thereby to form a hard and solid piece of the decoration article which is then laterally or vertically dissevered in equal space into specific horizontal-type or vertical-type slat pieces; whereby, via the woven fabric, the slat pieces thereof are equipped with artistic weaving diagrams of rich colors and three-dimensional designs at the upper and lower surfaces thereon; besides, the woven fabric, securely hold by the supported sticks and protected by the adhesive layer, can efficiently avoid the loose yarns in cutting operation thereof, precisely preventing the slat pieces from coming or wearing off after long time of repeated friction in use to achieve longer using lifespan of the slat pieces thereof.

Please refer to FIGS. 1 to 2 inclusive. Conventional horizontal-type and vertical-type slat pieces 1, 1′ are molded via plastics into elongated and slim solid color slat pieces of sufficient strength and hardness before diagrams 2, 2′ are printed or hot-pressed onto the surfaces of the horizontal-type and vertical-type slat pieces 1, 1′ respectively. Finally, cord passage holes, 3, 3′ are punched at the slat pieces 1, 1′ thereon for retaining cords to be led there-through.

There are some drawbacks to the above conventional slat structures. First, the horizontal-type and vertical-type slat pieces 1, 1′, made of plastics, must be individually formed via injection molding, which is complex in the process and thus unable to be quickly produced on a massive scale. Besides, the slat pieces 1, 1′ must be further processed via printing or hot-pressing to apply the diagrams 2, 2′ onto the surfaces thereof, which may boost the cost of production and is rather uneconomical in efficiency. Second, after long time of repeated friction of the slat pieces 1 in use, 1′thereof, the diagrams 2, 2′ printed thereon can easily come or wear off, which not only mars the overall beauty of the blinds, but also reduces the using lifespan of the slat pieces thereof. Third, the horizontal-type and vertical type slat pieces 1, 1′, made of plastics, can increase the burden of the environment in recycle. When burned off in disposal, the slat pieces 1, 1′ thereof can also cause air pollution and harm the environment.

### SUMMARY OF THE PRESENT INVENTION

It is, therefore, the primary purpose of the present invention to provide a slat structure, including a plurality of support sticks integrally woven with a woven fabric into a piece of decoration article, and an adhesive layer coated at the upper and lower surfaces of the decoration article thereon respectively, securely binding the woven fabric and the support sticks thereby to form a hard and solid piece of the decoration article which is then laterally or vertically dissevered in equal distance into specific horizontal-type or vertical-type slat pieces with various and colorful weaving diagrams disposed thereon, facilitating a fast and easy processing thereof so as to reduce the cost of production and achieve economical efficiency thereof.

It is, therefore, the second purpose of the present invention to provide a slat structure wherein, via the woven fabric, the slat pieces thereof are equipped with artistic weaving diagrams of rich colors and three-dimensional designs at the upper and lower surfaces thereon; besides, the woven fabric, securely hold by the supported sticks and further protected by the adhesive layer at the upper and lower surfaces thereon, can efficiently avoid the loose yarns in cutting operation thereof, precisely preventing the slat pieces from coming or wearing off after long time of repeated friction in use to achieve longer using lifespan thereof.

It is, therefore, the third purpose of the present invention to provide a slat structure wherein, via the support sticks made of bamboo materials, the woven fabric, and the adhesive layer of food-used fastening agent, the slat pieces are easily disposed in recycle or burning off without causing any burden or air pollution to the environment to provide an eco-friendly slat pieces thereof.

### BRIEF DESCRIPTION OF THE DRAWINGS

FIG. 1 is a perspective view of a conventional horizontal-type slat piece.

FIG. 2 is a perspective view of a conventional vertical-type slat piece.

FIG. 3 is a perspective view of a decoration article of the present invention.

FIG. 4 is a cross sectional view of the present invention in cutting operation.

FIG. 5 is a perspective view of a horizontal-type slat piece of the present invention.

FIG. 6 is a perspective view of a decoration article of another embodiment of the present invention.

FIG. 7 is a cross sectional view of another embodiment of the present invention.

FIG. 8 is a perspective view of a vertical-type slat piece of another embodiment of the present invention.

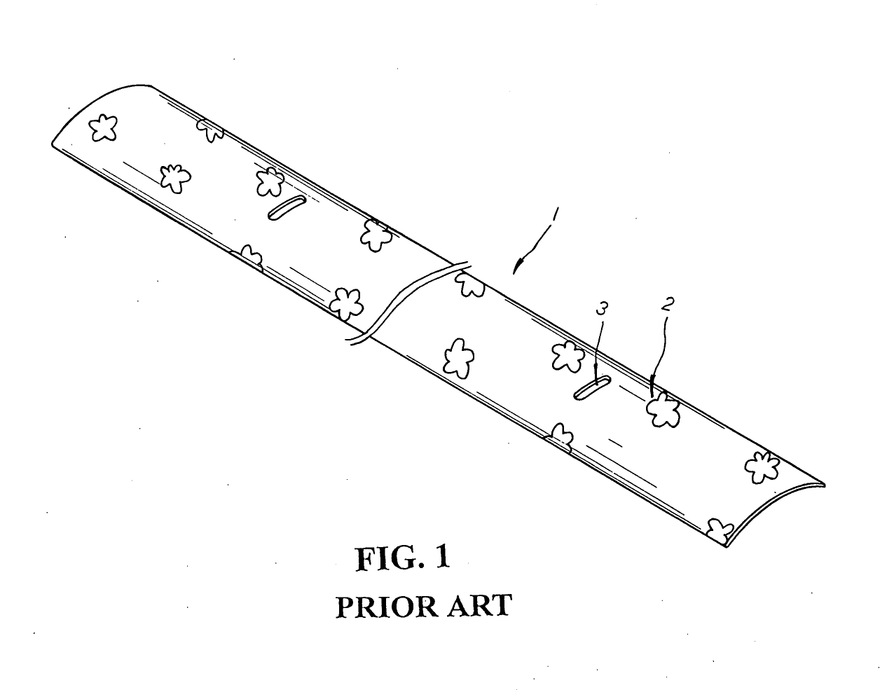

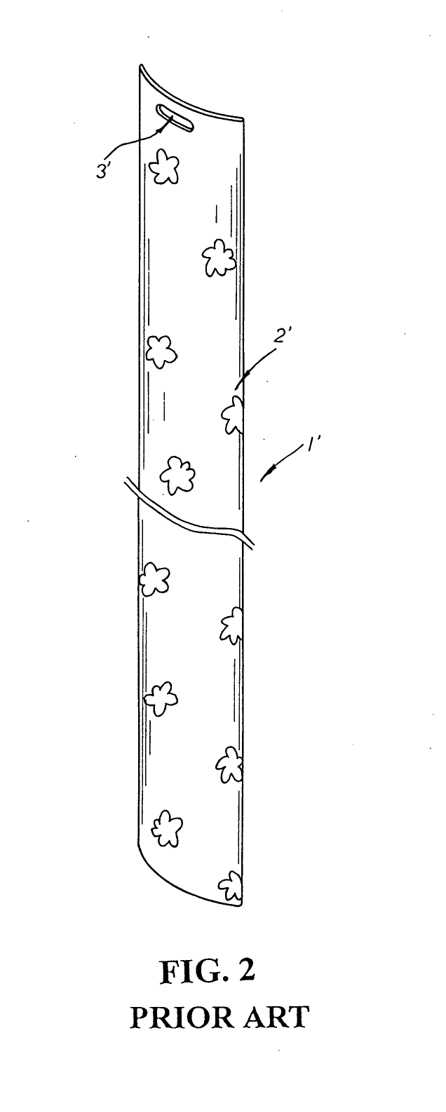

### DETAILED DESCRIPTION OF THE PREFERRED EMBODIMENTS

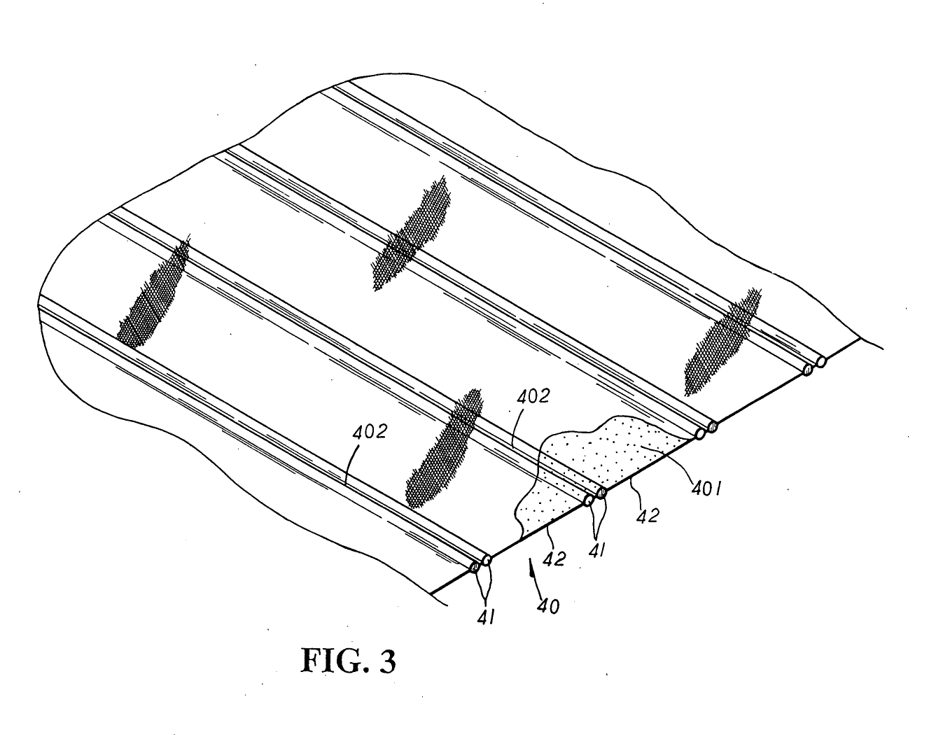

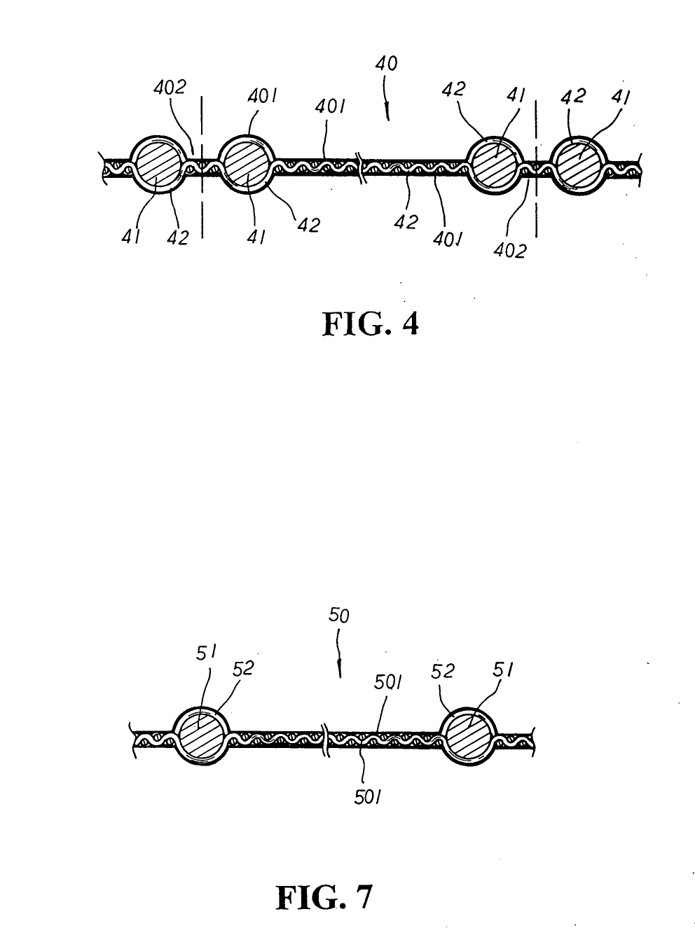

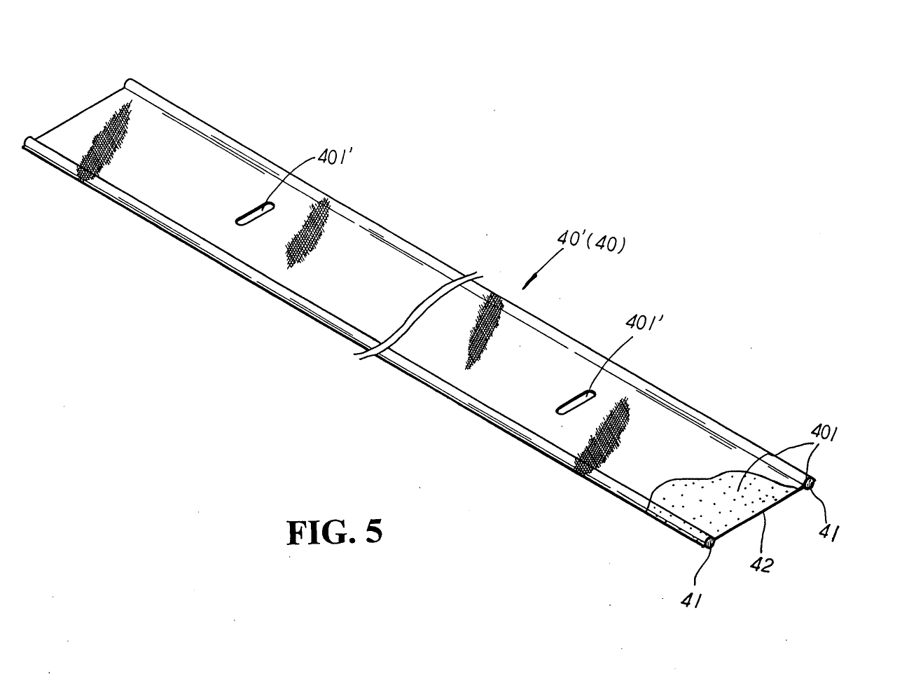

Please refer to FIGS. 3 to 5 inclusive. The present invention is related to a slat structure, comprising a plurality of support sticks 41 of bamboo materials equidistantly arranged in pairs and integrally woven with a woven fabric 42 into a piece of decoration article 40. The paired-up support sticks 41 are thus wrapped in place by the woven fabric 42 in equal distance. A food-used and transparent adhesive layer 401 is coated at the upper and lower surfaces of the decoration article 40 thereon respectively, securely binding the woven fabric 42 and the support sticks 41 thereby to form a hard and solid piece of the decoration article 40 thereof. A slim and elongated cutting area 402 is disposed between each pair of the support sticks 41 thereof, and diagrams of various designs are integrally woven at the surfaces of the decoration article 40 thereon. The decoration article 40 thereof is then laterally and equidistantly dissevered by the cutting areas 401 of the support sticks 41 thereof to form a plurality of specific horizontal-type slat pieces 40′ as shown in FIG. 5. A cord passage hole 401′ is properly disposed at each lateral surface of the horizontal-type slat piece 40′ thereon for a retaining cord to be led there-through. Thus, via the woven fabric 42, the horizontal-type slat piece 40′ is equipped with artistic weaving diagrams of rich colors and three-dimensional designs at the upper and lower surfaces thereon. Besides, the woven fabric 42 is securely hold by the supported sticks 41 and further bound by the adhesive layer 401 coated at the surfaces thereon, efficiently avoiding the loose yarns in cutting operation thereof. The horizontal-type slat pieces 40′ is then prevented from coming or wearing off after long time of repeated friction in use and precisely protected by the adhesive layers 40 coated at the upper and lower surfaces thereon so as to achieve longer using lifespan of the slat pieces 40′ thereof.

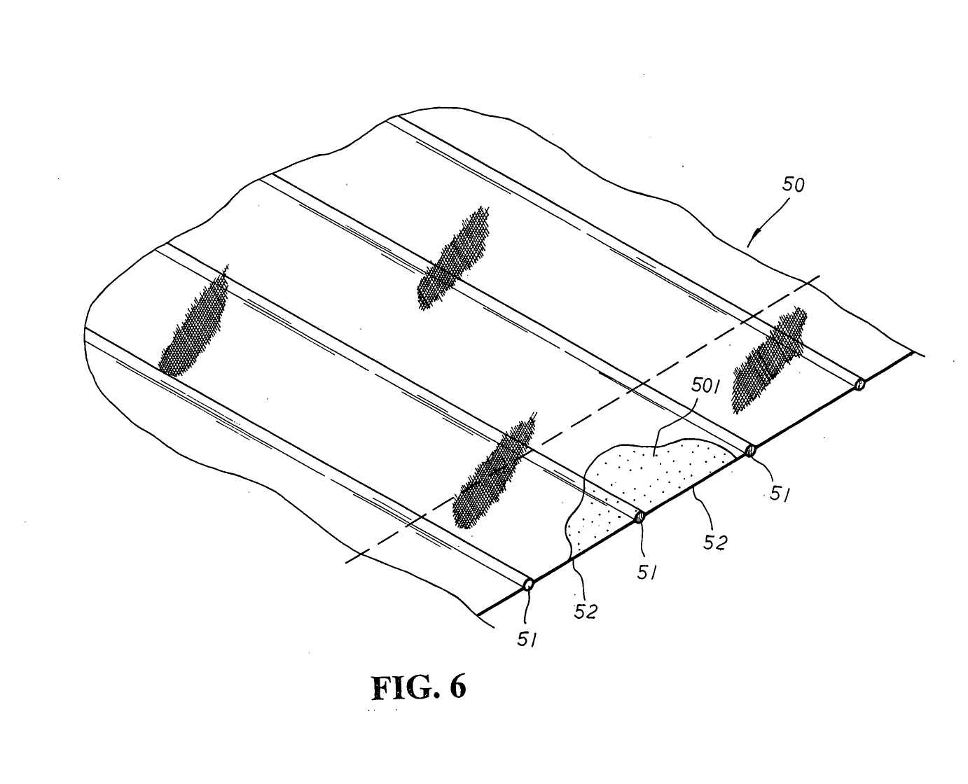

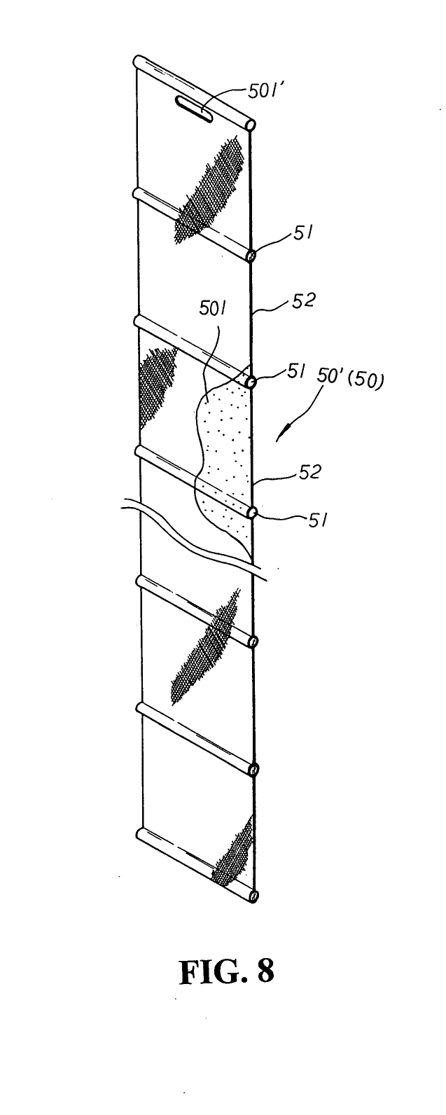

Please refer to FIGS. 6 to 8 inclusive. The present invention can also includes a plurality of support sticks 51 individually arranged in equal space and integrally woven with a woven fabric 52 into a piece of decoration article 50. The support sticks 51 are equidistantly wrapped in place by the woven fabric 52 thereof, and a adhesive layer 501 is coated at the upper and lower surfaces of the decoration article 50 thereof respectively, securely binding the woven fabric 52 and the support sticks 51 thereby to form a hard and solid piece of the decoration article 50 thereof. The decoration article 50 is then vertically and equidistantly dissevered into a plurality of specific vertical-type slat pieces 50′ each having a hook hole 501′ properly preset at one lateral side thereon as shown in FIG. 8. Thus, via the weaving of the woven fabric 52 thereof, the vertical-type slat pieces 50′ are equipped with artistic diagrams of rich colors and three-dimensional designs.

1. A slat structure, comprising a plurality of support sticks integrally woven with a woven fabric into a piece of decoration article wherein the support sticks are equidistantly wrapped in place by the woven fabric, and an adhesive layer is coated at the upper and lower surfaces of the decoration article thereon respectively, securely binding the woven fabric and the support sticks thereby to form a hard and solid piece of the decoration article which is then laterally or vertically dissevered in equal space into specific horizontal-type or vertical-type slat pieces; via the weaving of the woven fabric, the slat pieces thereof are equipped with artistic diagrams of rich colors and three-dimensional designs at the upper and lower surfaces thereon; besides, the woven fabric, securely hold by the supported sticks and further bound by the adhesive layer, can efficiently avoid the loose yarns in cutting operation thereof; thus, the slat pieces are precisely prevented from coming or wearing off after long time of repeated friction in use due to the protection of the adhesive layers coated at the upper and lower surfaces thereon, achieving longer using lifespan of the slat pieces thereof.

2. The slat structure as claimed in claim 1 wherein the support sticks thereof can be made of bamboo materials.

3. The slat structure as claimed in claim 1 wherein the adhesive layer can be made of food-used and transparent fastening agent.

4. The slat structure as claimed in claim 1 wherein the support sticks thereof can be equidistantly arranged in pairs and integrally woven with the woven fabric into the decoration article with a slim and elongated cutting area disposed between each pair of the support sticks thereof.

5. The slat structure as claimed in claim 4 wherein the decoration article is laterally dissevered in equal distance by the cutting areas of the paired-up support sticks thereof to form a plurality of specific horizontal-type slat pieces.

6. The slat structure as claimed in claim 5 wherein a cord passage hole is disposed at both lateral surfaces of each horizontal-type slat piece thereon respectively for a retaining cord to be led there-through.

7. The slat structure as claimed in claim 1 wherein the support sticks can also be individually arranged in equal space and integrally woven with the woven fabric into the decoration article thereof.

8. The slat structure as claimed in claim 7 wherein the decoration article is vertically dissevered in equal space to form a plurality of specific vertical-type slat pieces.

9. The slat structure as claimed in claim 8 wherein a hook hole is properly disposed at one lateral surface of each vertical-type slat piece thereof.
